(19) United States
(12) Patent Application Publication
(10) Pub. No.: US 2026/0051779 A1
(43) Pub. Date: Feb. 19, 2026

(54) SYSTEMS, METHODS, AND DEVICES, FOR ELECTRICAL MACHINES HAVING VARIABLE OPERATING CHARACTERISTICS

(71) Applicant: EPROPELLED INC., Gilford, NH (US)

(72) Inventor: Nabeel Ahmed SHIRAZEE, Cardiff (GB)

(73) Assignee: EPROPELLED INC., Gilford, NH (US)

(21) Appl. No.: 19/102,288

(22) PCT Filed: Aug. 7, 2023
(86) PCT No.: PCT/GB2023/052077

§ 371 Date: Feb. 7, 2025

Related U.S. Application Data
(60) Provisional application No. 63/371,035, filed on Aug. 10, 2022.

(51) Int. Cl. H02K 3/28; H02K 11/28; H02P 25/18; H02P 25/22

(52) U.S. Cl. CPC H02K 3/28; H02K 11/28; H02P 25/188; H02P 25/22; H02K 2213/09

(57) ABSTRACT

Exemplary embodiments of this disclosure include an electrical machine comprising windings (W) each divided into a plurality of sections (1-4) and a mechanical switch (12) having a plurality of switches (C1-Cn). Each switch (C1-Cn) comprises first and second portions (120, 121) which are displaceable relative to each other between first and second switching positions to respectively connect a first winding section (1-4) of windings WIN in series and/or in parallel with a second winding section of windings WIN. An actuator is provided for actuating for displacing the portions (120, 121) of each switch relative to each other between their first and second positions. The displacement of the portion can alter the operating characteristics of the electrical machine.

### BACKGROUND

### 1. Field of the Invention

The present invention relates to an electrical motor having output speed and torque characteristics which can be varied to achieve one or more desired parameters, although the disclosure equally relates to an electrical generator having variable input and output characteristics.

### 2. Related Background Art

The use of electrically powered vehicles is becoming widespread, and it is envisaged that such vehicles will eventually completely replace vehicles powered by combustion engines, mainly for environmental reasons and partly because of the diminishing resources of oil. Typically, electrically powered vehicles comprise a conventional electric motor coupled to a fixed or variable ratio mechanical gearbox for traction purposes. This means to gain torque advantage from the mechanical gears, the electric motor may have to rotate at a much faster speed. When an electric motor spins in the region of 12,000 rpm to 20,000 rpm it generally requires higher voltages such as 400V to 800V to achieve the desired speed-torque characteristics for an electric vehicle.

Using such high speeds with a traditional mechanical gearbox is not straightforward and the design has to be precise with tight tolerances to make such a system work reliably. This makes the manufacturing process expensive. Furthermore, high speed traction motors require significantly more expensive material to build than a lower speed traction motor that operates at around 6,000 rpm to 10,000 rpm. With lower traction speed motors the drivetrain of a hybrid or full electric vehicle becomes less complex and less expensive with traditional mechanical gearbox.

U.S. Pat. No. 7,382,103 discloses a so-called magnetic gearing system which is designed to alleviate the above-mentioned problems. The system comprises a permanent magnet brushless motor having three phase windings each divided into a plurality of separate winding sections and field-effect transistors (FETs) or other semiconductor devices for selectively connecting a respective winding section in series and/or parallel with other windings of that phase winding. The system further comprises a control device for actuating the FETs to connect the winding sections of each phase in different configurations whilst the motor is running to alter the speed and torque characteristics of the motor.

In use, when the motor is initially started, the FETs are controlled to connect each winding section of each phase in parallel. The parallel/series combination or a series connection is only selected to meet the torque requirements or a higher operating efficiency point. Accordingly, it will be appreciated that the efficiency of the motor is maximised without the need for traditional mechanical gearbox.

The magnetic gearing system of U.S. Pat. No. 7,382,103 is a unique system that offers many advantages and cost savings. In the automotive sector the traction motors for hybrid and full electric vehicles will benefit the most. This is because the system offers the capabilities of several motors combined into one motor without the need for a traditional gearbox. Furthermore, the system provides the advantage of being able to use a motor which operates at lower speeds and is thus less expensive and more reliable than those used in traditional electric vehicles.

Nevertheless, despite the above-mentioned advantages, we have found out that the electrical losses in the FET or other semiconductor devices of the magnetic gearing system of U.S. Pat. No. 7,382,103 can be high in series connection compared to parallel or any other combinations. Further, semiconductor devices can limit the voltage and current ratings, such that a plurality of expensive semiconductor switches have to be added in parallel to share the current load. Furthermore, since the waveform applied to the motor is alternating current (AC) (e.g., in varying shapes of waveform), each device requires a back-to-back arrangement to allow conduction in both directions.

Accordingly, the number of switches increases.

With the forgoing in mind, disclosed is an improved electrical machine having variable operating characteristics.

### SUMMARY

In accordance with embodiments of the invention, there is provided an electrical machine comprising: a winding having a plurality of winding sections, each section having first and second opposite ends; a mechanical switch comprising a plurality of switches, each switch comprising first and second portions which are displaceable relative to each other between first and second switching positions to respectively connect a respective winding section of the machine in series, in parallel or its various combinations with at least one other winding section; and an actuator for displacing the portions of each switch relative to each other between their respective first and second positions.

The electrical machine may be a motor or a generator and the term electric machine as defined herein includes but is not limited to motors, generators, permanent magnet machines, switched reluctance machines, axial flux machines, induction machines, coreless machines, yokeless machines, inductors, choke, transformers and the like.

Such machines can have application in market sectors such as aviation, marine, railways, space applications etc. In the case of a motor, the actuator can be actuated to connect all of the winding sections in series so that the motor has high torque and low speed characteristics, akin to a low gear of a conventional gearbox. The actuator can also be actuated to connect some of the winding sections in parallel and some of them in series so that the motor has intermediate torque and speed characteristics.

The actuator can also be actuated to connect all of the winding sections in parallel, so that the motor has low torque and high speed characteristics, akin to a high speed gear of a conventional gearbox. Any of the winding configurations can be used at lower speeds if the torque and speed characteristics of the vehicle allow it to operate more efficiently. Zero crossing arc suppressors can be used, if they are excited on the fly (under load).

An electrical machine in accordance with the present invention comprising a mechanical switch is much more efficient than the electrical machine with semiconductor switches as the electrical losses in the mechanical switch are far less than those of semiconductor switches with correct grade of material such as silver-tin oxide etc. Further, a mechanical switch is substantially less limited in voltage and current ratings than semiconductor switches. For this reason, the need to add several semiconductor switches in parallel to share the current load is avoided. Also, the use of a mechanical switch avoids the need to provide a back-to-back semiconductor arrangement to provide a bidirectional conductive path for an AC supply. Therefore, the number of switches needed is substantially reduced and the complexity is dramatically reduced. A mechanical switch has the advantage of being small and compact and is cost-effective in a price sensitive market. Also, the use of a mechanical switch alleviates the problem of semiconductors being in short supply and eliminates the need for any substantial cooling that is needed for the semiconductor switches.

Furthermore, a mechanical switch has the advantage that substantially more winding configuration/gear formats can be provided in a compact unit to make the “gear” shifting in a vehicle smoother. This means transition between different torque steps is smaller and simulates a continuously variable transmission. With semiconductor switches, the size of the switch matrix increases with increasing the winding configuration. For example, a three-gear drive motor will have 54 semiconductor switches (excluding the parallel switches) compared with the present invention which will comprise a mechanical switch having just 9 switches.

The mechanical switch can comprise portions, where at least one portion moves relative to another portion. The mechanical switch can be a mechanical assembly. For example, first and second portions may move relative to each other. As another example, one portion may move while another portion remains stationary.

In some embodiments, the first portion of each switch may be provided with a plurality of contact terminals and the second portion of each switch may be provided with a plurality of conductive interconnects (e.g., electrical wiper contacts) for interconnecting selected contact terminals in different configurations in the first and second positions respectively. The electrical wiper contacts are normally made from materials such as carbon or graphite or silver-tin oxide and each contact is isolated from one another. In some embodiments, each contact may be completely isolated from one another. The contact terminals can be made of material such as beryllium copper, where either the winding of the stator is terminated, or it is connected to the star point or live phases. In some embodiments, the first portion of each switch may comprise first and second contact terminals respectively connected to an end of two winding sections and third and fourth contact terminals for connecting said two winding sections to a supply conductor, the first and second contact terminals being interconnected by a said conductive interconnect in the first switching position to connect said two winding sections in series, the first and third contact terminals being interconnected by a second conductive interconnect and the second and fourth contact terminals being interconnected by the a third conductive interconnect in the second switching position to connect said two winding sections in parallel. The third conductive interconnect can connect two winding sections in parallel between the supply conductor.

In some embodiments, each switch may have a third switching position in which the respective winding section of the machine is disconnected.

In some embodiments, the actuator may be moveable between a plurality of positions in which the combination of positions of each switch of the mechanical switch are different. The actuator may be movable directly or indirectly from a first position to a second position via one or more intermediate positions, for example, wherein most of the winding sections are connected in series in the first actuator position and most of the winding sections are connected in parallel in the second actuator position, wherein the mechanical switch is arranged to selectively connect winding sections in parallel as the actuator is moved into one or more intermediate positions between the first and second positions.

In some embodiments, the mechanical switch may comprise the actuator to move portions of the mechanical switch. In some embodiments, the actuator may comprise a single actuator. In some embodiments, the actuator may comprise multiple actuators.

In some embodiments, the actuator may comprise a single actuator for simultaneously or selectively displacing the portions of each switch relative to each other between their respective first and second positions.

In some embodiments, the actuator may be configured to actuate a switch portion comprising one or more of a disc, a ring, a cylinder, a linear, and an arcuate member. In some embodiments, the first portions of each switch may be fixed relative to each other. Similarly, the second portions of each switch may be fixed relative to each other.

As an example, the first portions of each switch may be provided on a fixed member (e.g., a first switch portion) and the second portions of each switch may be provided on a movable member (e.g., a second switch portion) or vice-versa. In this example, when the movable member moves, second portions of each switch may move together. In some embodiments, second portions of each switch may move to move into contact with first portion of each switch.

In some embodiments, the first portions of each switch and /r the second portions of each switch may be independently moveable relative to at least one other such portion of other switches. The portions of each switch may be interconnected such that movement of one portion causes movement of another portion for example via a gearing or an indexing mechanism. As an example, the first portions of each switch may be provided on respective members which move sequentially. In some embodiments, a first movement may engage some first portions of each switch, a second movement may engage more or different first portions of each switch, and a third movement may engage every first portion of each switch.

In some embodiments, the first and second portions of each switch may be movable linearly or arcuately relative to each other. The first and second portions may be movable by an actuator. In one embodiment, the first and second portions of each switch may be movable relative to each other in a single plane. In another embodiment, the first and second portions of each switch may be movable relative to each other in a plurality of planes. As an example, the first and second portions of each switch may be movable arcuately relative to each other in a plurality of planes which can be selected by moving the first or second portion of each switch linearly between the planes.

In some embodiments, the actuator may be arranged to displace the portions of each switch relative to each other automatically, manually, or semi-manually to reconfigure the windings of the electric machine.

In some embodiments, in an automatic mode, the portions of each switch may be displaced relative to each other based on a control program stored in a control unit of the switching device. For example, the control unit may be arranged to compare the actual rotational speed and torque of the machine against predetermined values and to operate an actuator to selectively displace the portions of each switch when the actual value falls outside a predetermined range of values.

In some embodiments, in a manual mode, the portions of each switch may be displaced relative to each other implemented based on movement of the actuator by a user (e.g., via a command, a button, a shifter).

In some embodiments, in a semi-manual mode, a control unit comprises a switch which can be actuated by a user to operate an actuator to selectively displace the portions of each switch to select the desired configuration of the windings of the machine.

In some embodiments, a switch may be provided to momentarily inhibit the electrical supply to the windings whilst any switch of the switching device is moved between its first and second position. Zero crossing arc suppressors can be used where the electrical supply to the windings is not turned off whilst any switch of the switching device is moved between its first and second positions. The portions of each switch may be immersed in fluid in a hermetically sealed unit. The fluid prevents arcing under heavy current during on-load switching.

The present invention provides an arrangement which is compact, electrically efficient, cost-effective, simple, easy to manufacture and accommodates a multitude of winding combinations/configurations and improves the switching efficiency over the present switching devices.

### BRIEF DESCRIPTION OF THE DRAWINGS

Embodiments of the present invention will now be described by way of examples only and with reference to the accompanying drawings, in which:

FIG. 1 is a schematic view of an embodiment of an electric motor;

FIG. 2 is a schematic circuit diagram of phase connections of the motor of FIG. 1;

FIG. 3 is a circuit diagram of a phase winding and switching assembly of the motor of FIG. 1;

FIG. 4 is a plan view of a portion of a mechanical switching device of the phase winding and switching assembly of FIG. 3;

FIG. 5 is a sectional view along the line v-v of FIG. 4;

FIG. 6 is a schematic circuit diagram of phase connections of a second embodiment of electric motor;

FIG. 7 is a plan view of a first portion of a mechanical switching device of the second embodiment of electric motor;

FIG. 8 is a plan view of a second portion of the mechanical switching device of the second embodiment of electric motor;

FIG. 9 is a schematic side view of the mechanical switching device and motor unit of a third embodiment of electric motor; and

FIG. 10 is an exploded view showing the first and second portions of the mechanical switching device of the third embodiment of electric motor.

### DETAILED DESCRIPTION OF THE PREFERRED EMBODIMENTS

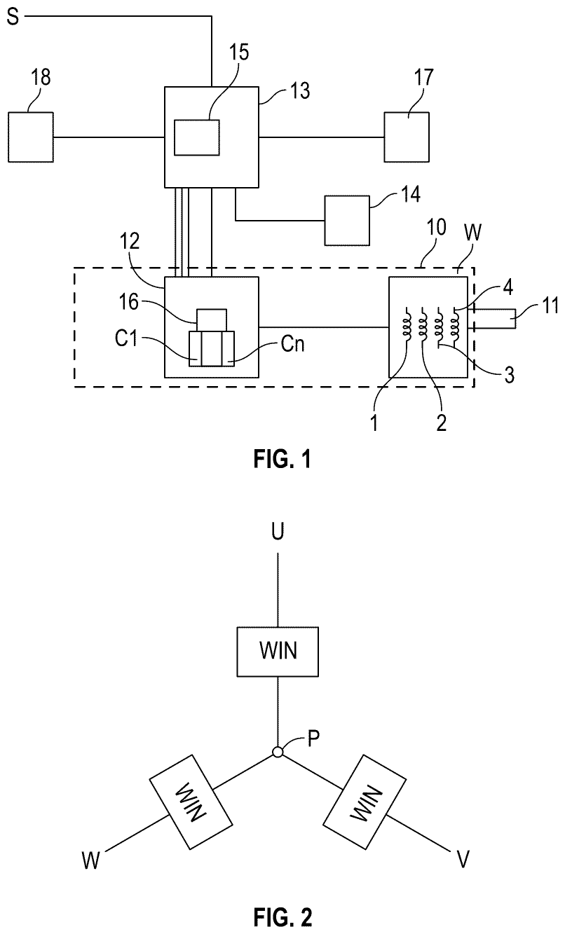

Referring to FIG. 1 of the drawings, there is shown an electric motor comprising a 3-phase permanent magnet brushless motor unit 10 having a rotary output shaft 11. The motor unit 10 can be electrically connected to a mechanical switch 12 comprising a plurality of switches C1 to Cn. The mechanical switching device 12 is connected to a supply S via a control unit 13. The control unit 13 may be connected to one or more sensors (e.g., 14) for sensing operating parameters of the motor unit 10 such as its operating speed, torque, temperatures, or inductances. The control unit 13 may comprise an isolator switch 15 for isolating the mechanical switching device 12 from the supply S. An actuator 16 is provided for changing the conductive state of each switch (e.g., C1) of the mechanical switching device 12. The actuator 16 may be a mechanical actuator which can be moved or operated by a user or it can be an electronic device such as a solenoid or stepper motor or a servomotor. In some embodiments, a user can physically cause the mechanical actuator to use via a lever or similar. In the case of an electronic actuator, the control unit 13 may comprise a selector switch 17 for causing movement of the actuator 16.

Switches (C1 . . . Cn) can be phase-changing switches (not semiconductor) where its state can be changed from conducing to non-conducting by applying light or pressure or voltage like in OLED switches.

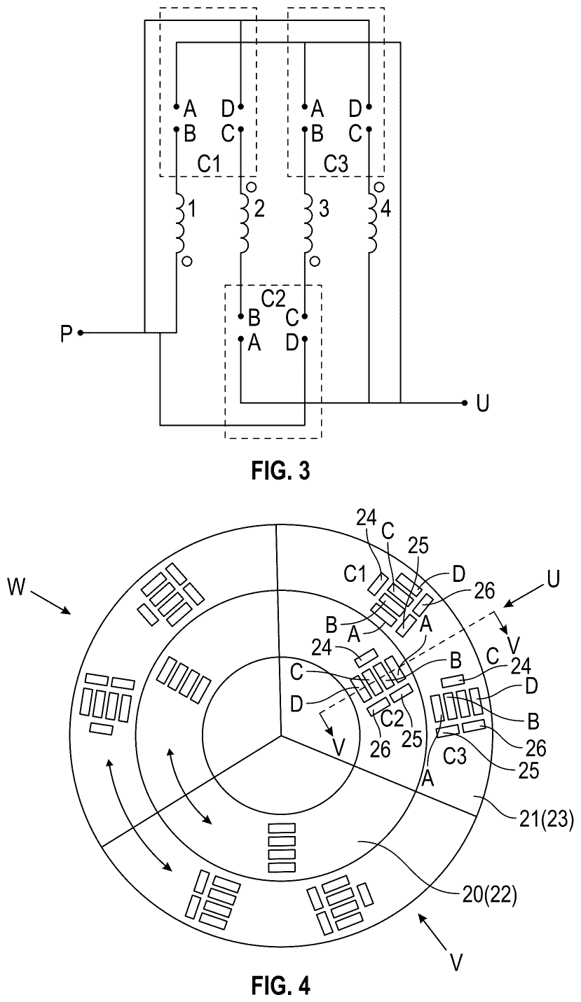

Referring to FIGS. 2 and 3 of the drawings, the motor unit 10 of the depicted embodiment of electric motor can have three different winding configurations comparable with having three gears. The motor unit 10 can comprise three stator winding assemblies “WIN” connected in a star configuration between a common point P and respective phase lines U, V, W of a three-phase supply. Each phase winding assembly “WIN” may comprise a winding having four conductors or so-called winding sections 1-4 which may be co-wound in parallel through stator slots of the motor unit 10. A motor having more than three different winding configurations will have a motor unit 10 having greater number of winding sections.

Referring to FIG. 3, the first end of the first winding section 1 of each phase, e.g., phase U, may be connected to the first ends of the first winding sections of the other two phases V, W at common point P. The second end of the fourth winding section 4 of each phase (e.g., phase U) may be connected to the respective phase supply line (e.g., P, U).

The mechanical switch 12 of the depicted motor may have three gears comprising three switches C1, C2 and C3 for each phase i.e., nine switches in total. Each switch of each phase can comprise a configuration exemplified by C1 of FIG. 3, which comprises:
a first terminal B connected to a second end of a respective winding section of that phase e.g., winding section 1;
a second terminal C connected to a first end of a respective adjacent winding section of that phase e.g. winding section 2;
a third terminal A connected to the respective phase supply line of that phase e.g. supply line U; and
a fourth terminal D connected to the common point P.

As will be appreciated from FIG. 3, winding sections 1-4 may be considered adjacent winding sections.

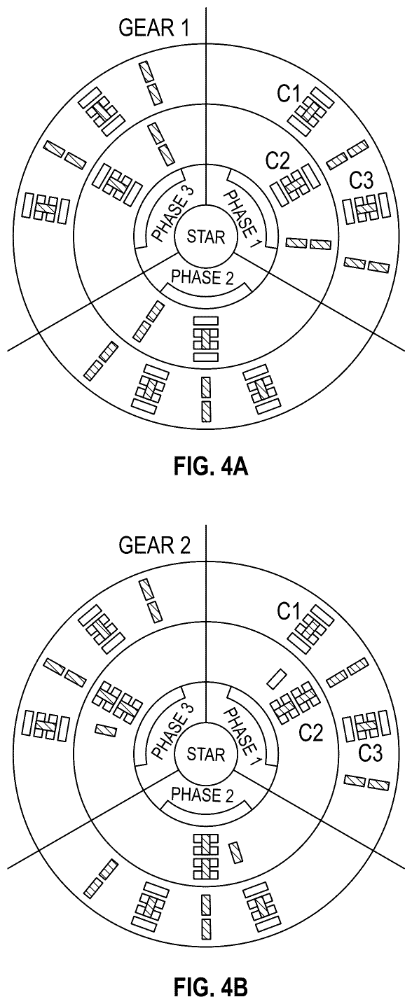

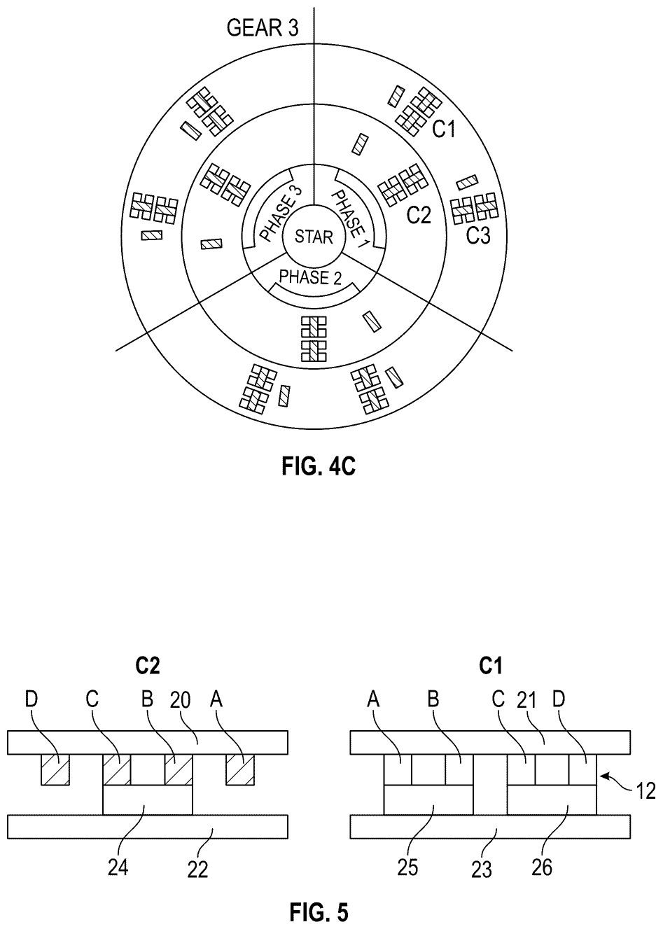

Referring to FIGS. 4 and 5 of the drawings, the mechanical switching device 12 comprises an inner and outer annular fixed rings 20, 21 which are fixed to a body of the mechanical switch 12. Each ring 20, 21 can be divided into three quadrants for the respective phases. For example, the inner annular ring 20 can comprise the first, second, third and fourth terminals D, C, B, A of the switch C2 of each phase in respective quadrants. As another example, the outer annular ring 21 can comprise the first, second, third and fourth terminals D, C, B, A of the switches C1 and C3 of each phase in respective quadrants.

The mechanical switch 12 can further comprise inner and outer annular rotatable rings 22, 23 mounted face-to-face respectively with the aforementioned fixed rings 20, 21.

The rotatable rings 22, 23 can be independently rotatable in a common plane which can lie parallel to the plane in which the fixed rings 20, 21 lie. Each rotatable ring 22, 23 may be divided into three quadrants for the respective phases. The inner rotatable ring 22 may comprise a first, second and third conductive interconnects 24, 25, 26 of the switch C2 of each phase in respective quadrants. The outer rotatable ring 23 may comprise the first, second and third conductive interconnects 24, 25, 26 of the switches C1 and C3 of each phase in respective quadrants. The first conductive interconnect 24 of the switches C1 to C3 of each phase can be circumferentially separated on the rotatable rings from their respective second and third conductive interconnects 25, 26.

The rings 20, 21, 22, 23 may be immersed in the liquid such as oil in a hermetically sealed cavity inside the mechanical switch 12. In some embodiments, every contact may be immersed.

In use, the rings 20, 21, 22, 23 may be initially aligned as shown in FIG. 4 and the isolator switch 15 can be operated to disconnect the three-phase supply S from the mechanical switch 12. The actuator 16 can then be actuated to rotate the inner and outer annular rotatable rings 22, 23 through an angle, for example of approximately 15° clockwise relative to the fixed rings 20, 21, so that the first conductive interconnects 24 of each switch C1, C2 & C3 engage and electrically connect the second and third terminals B & C of the respective switches, thereby connecting all four winding sections 1, 2, 3, 4 of each phase in series between the common point P and the respective phase supply line of that phase e.g., supply line U. The isolator switch 15 can then be operated so that the supply current flows through each series-connected section 1-4 in the same direction with respect to each section's polar orientation to avoid conflicting flux. For example, if one of the sections (e.g., section 4) is oriented in the opposite direction, the flux produced by section 4 may undesirably oppose the flux produced by sections 1, 2 and 3. In exceptional cases, direction may be reversed in certain sections.

The torque of the motor may be directly proportional to the current and, as long as the starting torque is high enough to overcome the load attached to the motor, the rotor and the shaft 11 begin to turn and will accelerate until the torque produced equals the load. For example, the motor can continue to rotate at a constant speed. If the load is altered, the motor can automatically adjust its torque (and consequently, its speed) in order to balance the load.

When all winding sections 1, 2, 3, 4 of each phase are connected in series, the motor may have a high torque characteristic but a low speed akin to the first or lower gear of a traditional motor-vehicle. Starting from a Gear 1 position as shown in FIG. 4a, the configuration of the winding sections 1, 2, 3, 4 of each phase can then be varied by rotating the inner and/or outer annular rotatable rings 22, 23 relative to the inner and outer fixed rings 20, 21 in order to further select Gear 2 or Gear 3. For example, the inner annular rotatable ring 22 can then be rotated by the actuator 16 through an angle, for example of 30° in the counter clockwise direction relative to the inner fixed ring 20, so that the second and third conductive interconnects 25, 26 of the switch C2 respectively engage and electrically connect the first and second terminals A & B and the third and fourth terminals C & D of the switch C2, thereby connecting the first and second winding sections 1 & 2 in parallel, in series with winding sections 3 & 4 in parallel thereby creating Gear 2 as shown in FIG. 4b. This may be considered to be a similar motor profile as that of an intermediate or higher gear of a traditional engine.

The outer rotatable ring 23 can then be rotated by the actuator 16 through an angle 30° in the anti-clockwise direction relative to the outer fixed ring 21, so that the second and third conductive interconnects 25, 26 of the switches C1 and C3 respectively engage and electrically connect the first and second terminals A & B and the third and fourth terminals C & D of the switches C1 and C3, thereby connecting all of the winding sections 1, 2, 3, 4 directly and in parallel between the common point P and the respective phase supply line of that phase e.g. U thus creating Gear 3 as shown in FIG. 4c. In this manner 25% of the supply current flows through each winding sections 1, 2, 3, 4. Accordingly, the speed of the motor may be further increased, and the torque further decreased compared to when all winding sections 1, 2, 3, 4 of each phase are connected in series. This may be considered to be a similar motor profile as that of a high or higher speed gear of a traditional engine.

It will be appreciated that the efficiency of the motor is thus increased without the need for traditional gearing such as transmission of power through a gearbox with an increase or reduction of speed and/or torque based on a selected mechanical gear.

For example, the winding configurates may be changed from a high torque configuration to a high speed configuration and bypass intermediate configurations. As another example, the winding reconfigurations can change from any configuration to another configuration, so that the windings may be changed from a series connected configuration directly to a parallel configuration without utilising the intermediate configuration. In some embodiments, the isolator switch 15 can be operated each time the configuration is changed to provide an effective gear change which is smooth and without the risk of electrical arcing. In some embodiments, the actuator 16 could be a manual actuator which is commanded to move by a user (e.g., through a shifter, a button, a lever) to select the desired effective gearing or it could be an electrically operated actuator controlled by the control unit 13 according to feedback from the sensors 14. Alternatively, the actuator 16 could be an electrically operated actuator controlled by the control unit 13 according to signals received from the selector switch 17.

The present invention enables the required speed and torque to be achieved within a single electric motor or generator without the need of expensive mechanical gearing/gearbox. Accordingly, it will be appreciated that the required range of speed and torque can easily be achieved within the current confines using a reasonably sized direct drive motor with only a fixed ratio gear.

The winding sections 1, 2, 3, 4 within each phase need not be wound using the same wire diameter or the same number of turns. In some embodiments, the phases can be wound differently, with a different wire diameter, or a different number of turns. In some embodiments, the phases can be wound in an identical manner. For instance, winding section 1 of every phase can be wound with the same wire and have the same number of turns. As an example, winding section 2 can have a different number of turns and it can be wound using a different wire diameter to that of winding section 1, But it can be advantageous to wind each coil segment similarly. For each coil segment, for example, coil segment 2 of every phase can be wound with the same wire and have the same number of turns.

It will be appreciated that whilst the embodiment hereinbefore described utilises 3-phases, a motor in accordance with the present invention can have any number of phases. Furthermore, the invention also applies to electric machines, which can have similar speed torque characteristics as motors described herein. It will also be appreciated that the invention could be applied to electrical generators. It will also be appreciated that the above-mentioned winding configurations are not the only possible combinations. For example, another possible combination is winding sections 1 and 2 connected in parallel and winding sections 3 and 4 connected in parallel to each other and in series with winding sections 1 and 2. This configuration will produce an effective extra gear between.

Yet another configuration can be obtained by turning the outer rotatable ring 23 to a counter clockwise position and by turning the inner rotatable ring 22 to a clockwise position, thereby connecting winding sections 2 and 3 in series between the common point P and the respective phase supply line of that phase e.g., supply line U and connecting both winding sections 1 and 4 in parallel thereto, so as to yield a gearing characteristic between the aforementioned low and intermediate gearing characteristics. Further configurations can be provided by providing an independently rotatable ring for each switch C1, C2, C3.

In an alternative embodiment, corresponding members may be used instead of the rotatable and fixed rings 20, 21, 22, 23, where the corresponding members can move linearly relative to each other as opposed to rotationally.

The aforementioned sequences explained above allow reconfiguring the windings of an electric machine by rotating the ring 23 by an appropriate angle in the clockwise or counter clockwise direction. Because the winding sections “WIN” are switched in an electro-mechanical way using special electrical contacts having low resistance, the losses can be substantially reduced compared to semiconductor switching and the system can be more electrically efficient and reliable.

This electro-mechanical method of switching is also cost-effective and reduces the number of switches in a manner which can easily be accommodated in any electric machinery where reconfigurable windings are beneficial to the system.

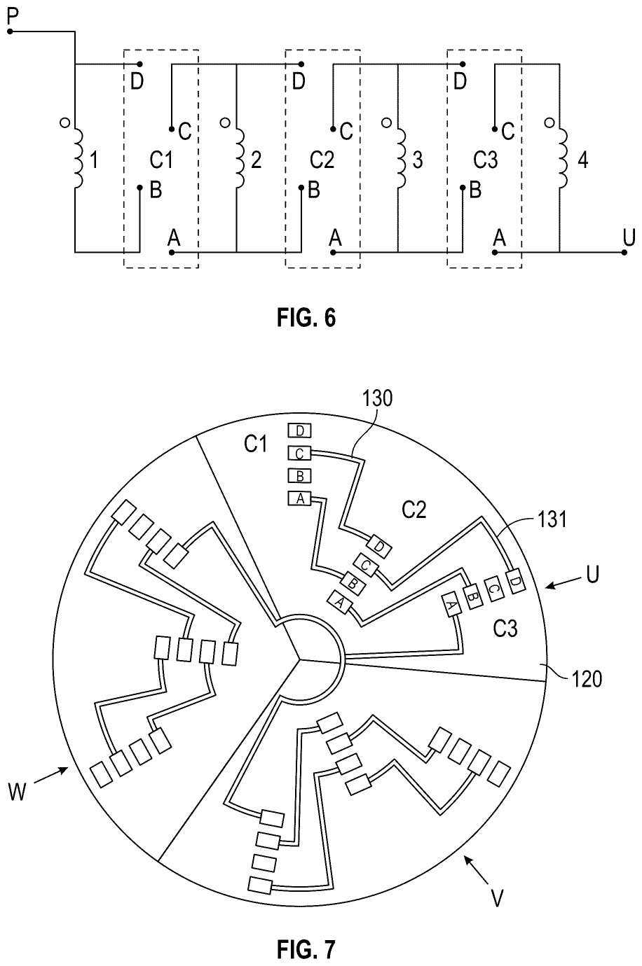

Referring to FIGS. 6, 7 & 8 of the drawings, a mechanical switch of an alternative embodiment is similar to that of FIGS. 1 to 5 and like parts are given like reference numerals. In the embodiment illustrated in FIGS. 6, 7 & 8, the first end of the first winding section 1 of each phase e.g., phase U is similarly connected to the first ends of the first winding sections of the other two phases V, W at common point P. The second end of the fourth winding section 4 of each phase (e.g., phase U) is similarly connected to the respective phase supply line.

The switching device may comprise three switches C1, C2 and C3 for each phase i.e., nine switches in total. Each switch of each phase can comprise a configuration exemplified by C1 of FIG. 6, which comprises:
a first terminal B connected to a second end of a respective winding section of that phase e.g., winding section 1;
a second terminal C connected to a first end of a respective adjacent winding section of that phase e.g., winding section 2;
a third terminal A connected to a second end of the respective adjacent winding section of that phase e.g., winding section 2; and
a fourth terminal D connected to a second end of the respective winding section of that phase e.g., winding section 1.

As will be appreciated from FIG. 6, winding sections 1-4 may be considered adjacent winding sections.

In FIG. 7, the mechanical switch 12 can comprise a disc 120 which is fixed to a body of the mechanical switch 12. The disc 120 can be divided into three quadrants for the respective phases U, V, W. The upper side of the disc 120 carries the first, second, third and fourth terminals D, C, B, A of the switches C1, C2 and C3 of each phase U, V, W in respective quadrants.

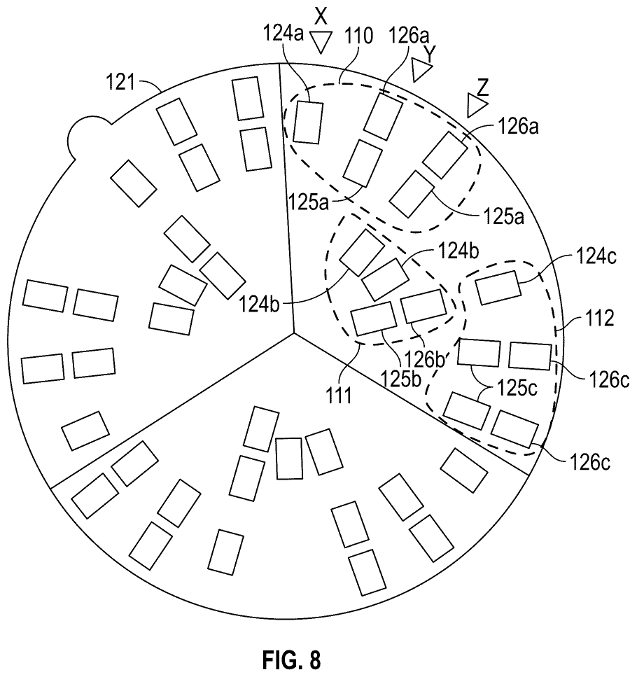

In FIG. 8, the mechanical switch 12 can comprise a rotatable disc 121 mounted face-to-face with the aforementioned fixed disc 120. The rotatable disc 121 can be rotatable in a plane which lies parallel to the plane in which the fixed disc 120 lies. The rotatable disc 121 is divided into three quadrants for the respective phases U, V, W.

For illustrative purposes only, the rotatable disc 121 is shown formed of a transparent substrate so that the conductive interconnects on the underside thereof are visible.

The conductive interconnects on underside of the rotatable disc 121 can be arranged in a plurality of groups 110, 111, 112 which are circumferentially and radially separated from each other and which form part of the switches C1, C2 and C3 respectively.

The interconnect group 110 of switch C1 comprises a first conductive interconnect 124a at circumferential position X, and first and second sets of second and third conductive interconnects 125a, 126a at circumferential positions Y and Z respectively.

The circumferential positions X, Y and Z lie at an angle, for example of 17.5°, from each other. The interconnect group 112 of switches C3 has the same pattern of interconnects as that of interconnect group 110 but is circumferentially separated therefrom by an angle, for example 70°. The interconnects 124c, 125c, 126c of switch C3 can lie at similar radial positions as the corresponding interconnects 124a, 125a, 126a of the switch C1.

The interconnect group 111 of switch C2 can comprise a first conductive interconnect 124b at circumferential position X, a second conductive interconnect 124b at circumferential position Y and second and third conductive interconnects 125b, 126b at circumferential position Z. The interconnect group 111 of switch C2 can be disposed between the interconnect groups 110, 112 and is circumferentially separated by an angle, for example by 35°. The interconnects 124b, 125b, 126b of switch C2 can lie radially inwardly of the interconnects of the other groups 110, 112.

The discs 120, 121 may be immersed in the liquid such as oil in a hermetically sealed cavity inside the mechanical switch 12.

In use, the discs 120, 121 can be initially aligned so that none of the conductive interconnects 124, 125, 126 (a, b, c) and the rotatable disc 121 make contact with the terminals A, B, C, D on the fixed disc 120. The isolator switch 15 can then be operated to disconnect the three-phase supply S from the mechanical switching device 12. The actuator 16 can then be actuated to rotate the rotatable disc 121 until the first conductive interconnect 124a of switch C1 at position X overlies and interconnects the first and second terminals D, C of the switch C1. Simultaneously, the first and second terminals D, C of the switches C2 and C3 can be interconnected by their respective first conductive interconnects 124b, 124c, thereby connecting all four winding sections 1, 2, 3, 4 of each phase in series between the common point P and the respective phase supply line of that phase e.g., U. The isolator switch 15 can then be operated so that the supply current flows through each series-connected section 1-4 in the same direction with respect to each section's polar orientation.

The configuration of the winding sections 1, 2, 3, 4 of each phase can then be varied by rotating the rotatable disc 121 by 17.5° in the counter clockwise direction until a first set of second and third conductive interconnects 125a, 126a of group 110 at position Y overlie and interconnect the first and third terminals D, B with the second and fourth terminals C, A respectively of switch C1. Simultaneously, a first set of second and third conductive interconnects 125c, 126c of group 112 can overlie and interconnect the first and third terminals D, B with the second and fourth terminals C, A respectively of switch C3. Simultaneously, another first conductive interconnect 124b of group 111 can overlie and interconnect the first and seconds terminals D, C with the second and fourth terminals C, A respectively of switch C2. In this manner, the first and second winding sections 1, 2 are connected in series between the common point P and the respective phase supply line of that phase e.g., supply line U and the third and fourth winding sections 3, 4 are connected in series between the common point P the respective phase supply line of that phase e.g., supply line U.

The configuration of the winding sections 1, 2, 3, 4 of each phase can then be further varied by rotating the rotatable disc 121 by an angle, for example a further 17.5° in the counter-clockwise direction, until the second set of second and third conductive interconnects 125a, 126a of group 110 at position Z can overlie and interconnect the first and third terminals D, B with the second and fourth terminals C, A respectively of switch C1. Simultaneously, the second set of second and third conductive interconnects 125c, 126c of group 112 can overlie and interconnect the first and third terminals D, B with the second and fourth terminals C, A respectively of switch C3.

Simultaneously, the second and third conductive interconnects 125b, 126b of group 111 can overlie and interconnect the first and third terminals D, B with the second and fourth terminals C, A respectively of switch C2. In this manner, all of the winding sections 1-4 may be connected in parallel between the common point P and the respective phase supply line of that phase e.g. supply line U.

It will be appreciated from FIG. 7 that the fixed disc 120 may be provided with a plurality of conductors e.g. 130, 131 which can interconnect the terminals D, C, B, A of the switches C1, C2, C3 thereby avoiding the need to hardwire the ends of each winding section 1, 2, 3, 4 to each other at the relevant points.

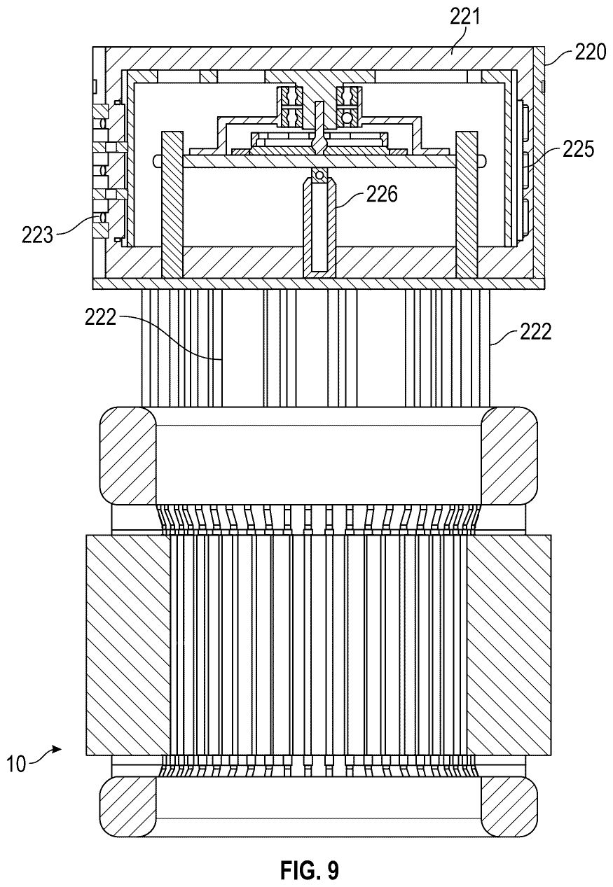

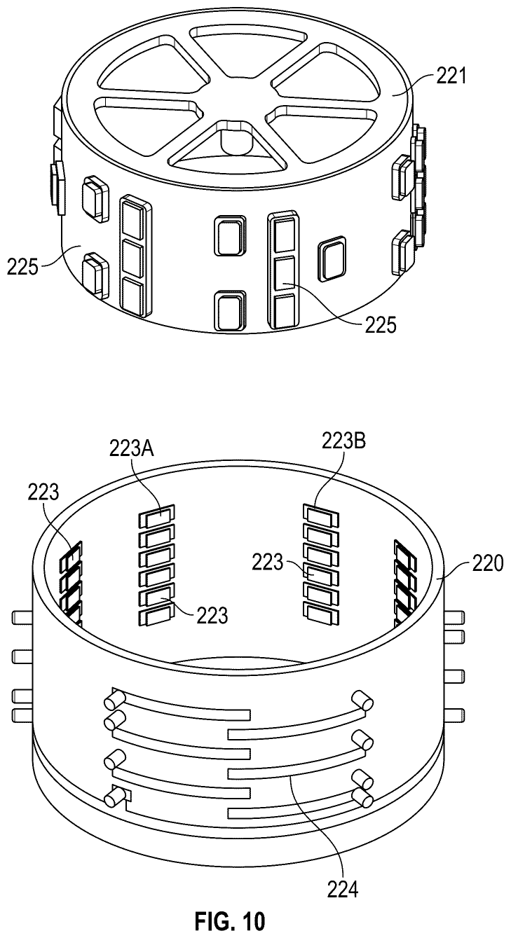

Referring to FIGS. 9 and 10 of the drawings, in an alternative embodiment, outer and inner cylindrical members 220, 221 can be used in the mechanical switch 12 instead of the discs 120, 121 of FIGS. 7 and 8. The cylindrical members 220, 221 can lie coaxially with the axis of rotation of the motor unit 10. The ends 222 of each stator winding “WIN” can extend axially of the motor unit 10 and can be terminated on the outer cylindrical member 220 along with the phase supply conductors. The ends of the windings and the phase supply conductors are appropriately connected to groups e.g., 223A, 223B of contact terminals 223 disposed on the radially inwardly facing tubular surface of the outer cylindrical member 220. The contact terminals 223 can be appropriately interconnected with each other as necessary by conductors 224.

The radially outwardly facing tubular surface of the inner cylindrical member 221 can be provided with a plurality of conductive interconnects 225. The inner cylindrical member 221 is rotatable about its axis and is also displaceable axially. The rotational and axial position of the inner cylindrical member 221 set by a servomotor 226 which is controlled by the electronic control unit 13.

During the start of the sequence, the default position of the cylindrical members 220, 221 may be in the neutral position in which the contact terminals 223 are not interconnected by any of the interconnects 225. In use, the inner cylindrical member 221 can be rotated and/or displaced axially by the servomotor 226 so that the conductive interconnects 225 thereon engage and appropriately interconnect the contact terminals 223 on the outer cylindrical member 220 so as to appropriately configure the windings in a similar manner to that as hereinbefore described.

It will be appreciated that any of the aforementioned mechanical switches 12 can be operated in fully automatic, manual, semi-manual control to appropriately reconfigure the windings “WIN” of the motor unit 10 of an electrical vehicle so as to provide a plurality of effective gears.

In a fully automatic mode of operation, the winding reconfiguration (shifting of gears) is implemented based on mapping software stored in the control unit 13, where speed and torque are regularly monitored by sensors 14 and compared with predetermined data stored within the software. Algorithms within the software determine when the shifting of the gear takes place.

In a manual mode of operation, instructions or an input may be received from a user to select an appropriate gear based on the user's experience of driving a vehicle. For example, the user may press a button to operate clutch 18 to momentarily operate the isolator switch 15 before shifting a lever to displace a ring, disc, cylinder or other portion of the mechanical switch into an appropriate position so as to appropriately interconnect corresponding terminals of mechanical switch 12. The momentarily disconnect may be as short as 1 ms and typically between 1 to 10 ms. When the clutch 18 is released, the supply can be applied to the appropriately configured windings of the motor unit 10. In this example, it will be appreciated that the process of pressing the clutch, shifting, and engaging the lever and releasing the clutch allow the user of the electric vehicle to experience a driving experience similar to a conventional manual transmission vehicle.

In a semi-manual mode of operation, an electronic gear actuator 16 within the switching device 12 can be operated in the same way as a hand pedal shifter in conventional vehicles. For example, when a user presses the selector switch 17, electrical signals can be transmitted to the switching device 12 to electronically change the winding configuration.

An electrical machine in accordance with the present invention overcomes the disadvantages of existing semiconductor switches and may be adapted for a variety of applications including the automotive industry, wind power generation, marine and aerospace applications for example.

An electrical machine in accordance with the present invention is compact, electrically efficient, cost-effective, simple, easy to manufacture and accommodates a multitude of winding combinations/configurations and improves the switching efficiency dramatically by reducing the contact resistance/switch resistance to a low value (lower than 1m ohm) compared with present semiconductor and other known switching arrangements.

1. An electrical machine comprising: a. a winding having a plurality of winding sections, each section having first and second opposite ends; b. a mechanical switch comprising a plurality of switches, each switch comprising first and second portions which are displaceable relative to each other between first and second switching positions to respectively connect a first winding section of the plurality of winding sections with the second winding section, wherein the first winding section is configured to be connected in series or in parallel with the second winding section; and c. an actuator for displacing at least one of the first and second portions of each switch relative to each other between the first and second switching positions.

2. An electrical machine as claimed in claim 1, in which each switch comprises a third switching position in which the first winding section of the machine is disconnected.

3. An electrical machine as claimed in claim 1, in which the first portion of each switch is be provided with a plurality of contact terminals and the second portion of each switch is provided with a plurality of conductive interconnects configured to interconnect selected contact terminals in different configurations in the first and second positions respectively.

4. An electrical machine as claimed in claim 3, in which the first portion of each switch comprises first and second contact terminals respectively connected to an end of two winding sections of the machine and third and fourth contact terminals for connecting said two winding sections to a supply conductor of the machine, the first and second contact terminals being interconnected by a said conductive interconnect in the first switching position to connect said two winding sections in series, the first and third contact terminals being interconnected by a second conductive interconnect and the second and fourth contact terminals being interconnected by the a third conductive interconnect in the second switching position to connect said two winding sections in parallel between the supply conductors.

5. An electrical machine as claimed in claim 1, in which the actuator is moveable between a plurality of positions in which the combination of positions of each switch of the mechanical switch are different.

6. An electrical machine as claimed in claim 5, in which the actuator is movable directly or indirectly from a first position to a second position via one or more intermediate positions, wherein most of the winding sections of the machine are connected in series in the first actuator position and in parallel in the second actuator position, wherein the mechanical switch is arranged to selectively connect winding sections in parallel as the actuator is moved into one or more intermediate positions between the first and second positions.

7. An electrical machine as claimed in claim 1, in which the actuator comprises a single actuator for displacing the portions of each switch relative to each other between their first and second positions.

8. An electrical machine as claimed in claim 1, in which the actuator may be configured to actuate a switch portion comprising a disc, a sphere, a ring, a cylinder or a linear or arcuate member.

9. An electrical machine as claimed in claim 1, in which the first portions of each switch and/or the second portions of each switch are be fixed relative to each other such portion of other switches.

10. An electrical machine as claimed in claim 9, in which the first portions of each switch are provided on a fixed member and the second portions of each switch are provided on a movable member or vice-versa.

11. An electrical machine as claimed in claim 9, in which the first portions of each switch and/or the second portions of each switch are independently moveable relative to at least one other such portion of other switches.

12. An electrical machine as claimed in claim 11, in which the portions of each switch are interconnected such that movement of one portion causes movement of another such portion via a gear or an index.

13. An electrical machine as claimed in claim 12, in which the first portions of each switch are provided on respective members which move sequentially.

14. An electrical machine as claimed in claim 1, in which the first and second portions of each switch are movable linearly or arcuately relative to each other.

15. An electrical machine as claimed in claim 14, in which the first and second portions of each switch are movable relative to each other in a single plane.

16. An electrical machine as claimed in claim 14, in which the first and second portions of each switch are movable relative to each other in a plurality of planes.

17. An electrical machine as claimed in claim 1, in which the actuator is arranged to displace the portions of each switch relative to each other automatically, manually or semi-manually, so as to reconfigure the windings of the electric machine.

18. An electrical machine as claimed in claim 17, in which in the automatic mode, the portions of each switch are displaced relative to each other based on a control program stored in a control unit of the switching device, the control unit being arranged to compare the actual rotational speed and torque of the machine against predetermined values and to operate an actuator to selectively displace the portions of each switch.

19. An electrical machine as claimed in claim 17, in which in the manual mode, the portions of each switch are displaced relative to each other implemented based on movement of the actuator by a user.

20. An electrical machine as claimed in claim 17, in which in the semi-manual mode, a control unit comprises a switch which can be actuated by a user to operate an actuator to selectively displace the portions of each switch to select a desired configuration of the windings of the machine.

21. An electrical machine as claimed in claim 1, in which a switch is provided to inhibit the electrical supply to the windings whilst any switch of the switching device is moved between its first and second position.

22. An electrical machine as claimed in claim 1, in which the portions of each switch are immersed in fluid in a sealed unit.
